(19) United States
(12) Patent Application Publication
(10) Pub. No.: US 2025/0111358 A1
(43) Pub. Date: Apr. 3, 2025

(54) SYSTEM AND METHOD FOR COLLECTING AND MANAGING CONTEXTUAL DATA RELATED TO ACTIVITY OF AI AGENTS IN AN COMPUTER EXECUTION ENVIRONMENT TO CREATE A CUSTOMIZED BRANDING EXPERIENCE

(71) Applicant: Futureverse IP Limited, Auckland (NZ)

(72) Inventors: Aaron McDonald, Auckland (NZ); Marco Brondani, Auckland (NZ); David McDonald, Auckland (NZ); Jesse Metcalfe, Auckland (NZ)

(21) Appl. No.: 18/905,878

(22) Filed: Oct. 3, 2024

Related U.S. Application Data
(63) Continuation-in-part of application No. 18/792,272, filed on Aug. 1, 2024.
(60) Provisional application No. 63/600,144, filed on Nov. 17, 2023.
(60) Provisional application No. 63/542,165, filed on Oct. 3, 2023.

(51) Int. Cl. G06Q 20/36

(52) U.S. Cl. CPC G06Q 20/3678

(57) ABSTRACT

A computer system and computer-implemented method for configuring attributes of at least one execution environment for an artificial intelligence (AI) agent is provided. The method includes executing an AI agent, the AI agent including a contextual memory associated with the AI agent, wherein the contextual memory is configured to store contextual data relating to experiences of the AI agent in the at least one execution environment. At least one biotag is derived from the contextual data, wherein the at least one biotag encapsulates experiences of the agent over time. In response to activity of the AI agent within the at least one execution environment, a subset of the at least one biotags is selected and attributes of the at least one execution environment are changed based on the biotag(s).

### RELATED APPLICATION DATA

This application is a Continuation-in-part of U.S. application Ser. No. 18/792,272 filed on Aug. 1, 2024, which claims priority to U.S. Provisional App. Ser. No. 63/600,144 filed on Nov. 17, 2023, and U.S. Provisional App. Ser. No. 63/542,165 filed on Oct. 3, 2023, the entire disclosures of which are incorporated herein by reference.

### FIELD OF THE INVENTION

The present disclosure generally relates to the management of artificial intelligence (AI) agents in an execution environment, such as a metaverse environment, an online game environment, and a financial services computing environment, and more specifically, to systems, methods, and devices that associate AI agents with a contextual memory for storing contextual data relating to the activity of the agent and interactions with other assets within various environments.

### BACKGROUND

Artificial Intelligence (AI) has become a cornerstone of modern technology, with applications spanning various fields, from healthcare to entertainment. One of the emerging applications of AI is in the realm of virtual environments, such as “metaverse environments”. “Metaverse refers to a collective virtual shared space where users can interact with a computer-generated environment and other digital assets, such as other users, in real-time.

In the metaverse, AI models (also referred to as “AIs” and “agents” herein) play a pivotal role. These agents are autonomous entities, such as characters represented by an avatar, that observe their environment and make decisions based on their observations to achieve specific goals. For example, the agent can be a game player in a metaverse game or a member of another online community. In other examples, the agent can be a Non Player Character (NPC), a financial services bot, a chatbot, or the like.

The digital landscape has undergone a significant transformation in recent years, evolving from static web pages to immersive virtual realities, augmented reality experiences, and interactive online games. As technology has advanced, user expectations have grown, with individuals seeking more tailored and real-time experiences in their digital interactions.

The integration of commercial opportunities within these digital environments has not kept pace with the rapid evolution of the technology itself. Traditional methods of digital advertising and e-commerce have struggled to fully capitalize on the potential of these new, immersive digital realms. While some attempts have been made to incorporate brand experiences and purchasing opportunities into virtual and augmented reality settings, these efforts have often been limited in scope and effectiveness.

One of the key challenges in this area has been the ability to provide truly personalized experiences that seamlessly blend commercial elements with the user's digital journey. Static product placements and conventional advertisements often fail to engage users in these dynamic, interactive environments. Additionally, the lack of real-time adaptation to user preferences and behaviors has hindered the potential for more targeted and effective brand integrations.

Furthermore, the fragmentation of digital experiences across various platforms and technologies has created obstacles for brands seeking to establish a consistent and engaging presence across multiple digital touchpoints. This fragmentation has also made it difficult for users to carry their preferences and experiences from one digital environment to another, leading to inconsistent and potentially frustrating interactions.

Further, as the lines between physical and digital realities continue to blur, there is a growing need for innovative solutions that can bridge these gaps and create more cohesive, personalized, and commercially viable digital experiences. Such solutions could potentially revolutionize how brands interact with consumers in the digital age, opening up new avenues for engagement and commerce while enhancing the overall user experience in these evolving digital landscapes.

### SUMMARY OF INVENTION

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

According to an aspect of the present disclosure, a computer-implemented method for configuring attributes of at least one execution environment for an artificial intelligence (AI) agent is provided. The method includes executing an AI agent, the AI agent including an identifier, an AI model that determines behavior of the AI agent, a value matrix that defines attributes of the AI agent, and a contextual memory associated with the AI agent, wherein the contextual memory is configured to store contextual data relating to experiences of the AI agent in the at least one execution environment, whereby the experiences are transferable with the AI agent across multiple execution environments. The method further includes deriving at least one biotag from the contextual data, wherein the at least one biotag encapsulates experiences of the agent over time. In response to activity of the AI agent within the at least one execution environment, the method includes selecting a subset of the at least one biotags. The method also includes changing attributes of the at least one execution environment based on the subset of the at least one biotag.

The identifier may be recorded on a decentralized ledger. The identifier may be a non-fungible token (NFT). Changing attributes of the at least one execution environment may include at least one of presenting targeted content to the AI agent in the at least one execution environment, changing behavior of assets in the at least one execution environment, and/or providing a product purchase interface to the AI agent in the at least one execution environment. The contextual memory may comprise a plurality of cards, each card containing data representing an interaction or attribute of a specific asset within at least one of the at least one execution environment. The data on the cards may include at least one of intrinsic information, dynamic information, and event information related to the specific asset. The non-fungible token (NFT) may be used to verify at least one of the authenticity and/or ownership of the AI agent. The value matrix may include attributes selected from the group consisting of: skills, appearance, knowledge, performance metrics, and user-defined characteristics. The contextual memory may be dynamically updated based on the interactions and activities of the AI Agent within the at least one execution environment. The at least one execution environment may include at least one of virtual reality, augmented reality, and gaming platforms. The contextual data may include data that relates to real-world experiences of a human associated with the AI agent. The Biotags can be derived by combining related units of contextual data or otherwise processing the contextual data.

The foregoing general description of the illustrative embodiments and the following detailed description thereof are merely exemplary aspects of the teachings of this disclosure and are not restrictive.

### BRIEF DESCRIPTION OF THE DRAWING

FIG. 1 is a block diagram of an AI agent in accordance with disclosed implementations.

FIG. 2 Illustrates details of a contextual memory and memory manger in accordance with disclosed implementations.

FIG. 3 is a flow chart of a method for using contextual data in accordance with disclosed implementations.

FIG. 4 illustrates a computer architecture in accordance with disclosed implementations.

FIG. 5 is a flow chart of a method for configuring an execution environment in accordance with disclosed implementations.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

U.S. Pat. No. 11,797,274 teaches associating NFTs with AI models to provide a mechanism for ownership of the AI model and the use of a “value matrix” in the context of AI that defines attributes or characteristics of an AI agent. These attributes can include skills, appearance, knowledge, performance metrics, and user-defined characteristics. These concepts are leveraged, and expanded upon, in the disclosed implementations.

The present disclosure relates to systems, methods, and computer-readable media for managing artificial intelligence (AI) agents in computing environments, such as metaverse environments. In some aspects, the present disclosure provides a computer-implemented method and system for associating an AI agent with a non-fungible token (NFT), and linking a contextual memory to the AI agent. The contextual memory is configured to store contextual data relating to the experiences of the AI agent, such as interactions of the AI agent with other elements in one or more execution environments. The contextual data allows experiences to be transferable with the AI agent across multiple execution environments, thereby enhancing the user experience in the computing environment.

Disclosed implementations also leverage concepts of “adaptive AI”, which refers to an artificial intelligence agent that is capable of learning as it encounters changes, both in data and the environment in which it operates. However, disclosed implementations can retain data across different environments, i.e., the data layer is accessible in any digital sphere. While conventional adaptive AI models are trained programmatically to interpret and adapt to new information, disclosed implementations include a data layer that provides any AI Agent with contextual data and information to understand, interpret and adapt to interactions and events in various dynamic environments.

Disclosed implementations allow the AI agent to utilize the contextual memory to store data about its past experiences, such as activities and interactions. This data can include information about the agent's environment, events it has participated in, and its interactions with other users or AI agents. The AI agent may use the stored contextual data to modify its behavior in future interactions. For example, if an AI agent has a negative interaction with a particular user or object, it may avoid similar interactions in the future, or if it has a positive interaction, it may seek out similar experiences.

Disclosed implementations i maintain learned behaviors and adaptations when transferred across multiple execution environments. This means that the AI agent can retain its experiences from one virtual space when moving to another, allowing for a consistent and evolving personality or set of behaviors across execution environments. The contextual memory can be persistently coupled to the AI agent to influence emergent behaviors based on the stored data. This suggests that the AI agent's decision-making processes are not static but can evolve as the contextual memory grows and changes.

The disclosed implementations provide an AI agent that is not just reactive to its immediate environment but is capable of complex behaviors that are shaped by a history of accumulated experiences, which are stored in a structured format (e.g., a schema or ontology) within the contextual memory. This allows the AI agent to exhibit a form of virtual learning and growth, akin to a living entity.

The contextual memory may comprise a plurality of “cards”, each card containing data representing an interaction or attribute of a specific asset within at least one of the multiple execution environments. The data on the cards may include intrinsic information, dynamic information, and event/interaction information related to the specific asset.

The cards may follow a specific, standardized format containing information that the asset provides to the AI during interactions. This card data can contribute to the pretext of the prompt, factoring in the distance between the asset (which can be an agent) and the agent, with a designated level of importance. Each card can also include a field to declare interactions with other assets. This structured format of the cards allows for a consistent and organized representation of the asset's attributes and interactions within the system and across disparate computing environments.

The structure and content of the cards in the contextual memory are designed to encapsulate detailed metadata about each interaction, including the object's biotags, the nature of the interaction (e.g., dialogue, combat, transaction), and the emotional or contextual significance. These cards serve as dynamic memory units, continuously updated, and expanded with new interactions and experiences. They enable the AI agent to recall past interactions, predict future behaviors, and adjust its actions, accordingly, ensuring a rich, evolving narrative driven by agent actions and interactions within the execution environment.

The system may include a non-fungible token (NFT) module, a contextual memory management module, and a contextual memory module. The NFT module is configured to associate AI agents with NFTs and enable transfer of ownership of the AI agents in a known manner. An input value matrix module can define attributes of the AI agents that can be interpreted across multiple metaverse applications. This value matrix may include a variety of parameters or characteristics that define the AI agent, such as its skills, abilities, knowledge, appearance, performance metrics, or other user-defined characteristics. The values in the input value matrix can be mapped to inputs of the AI model of the agent. Accordingly, the input value matrix may serve as a comprehensive profile (akin DNA) for the AI agent, providing a detailed and customizable representation of the AI agent's capabilities and attributes. For example, in a game, one or more values of the value matrix can specify the speed of the player/AI Agent.

The NFT may serve as a digital certificate of ownership for the AI agent, establishing a clear and verifiable record of ownership that can be transferred between users within the metaverse environment. This transferability of ownership may enable users to buy, sell, or trade AI agents in a secure and transparent manner, thereby enhancing the user experience and fostering a dynamic and vibrant marketplace for AI agents within the metaverse.

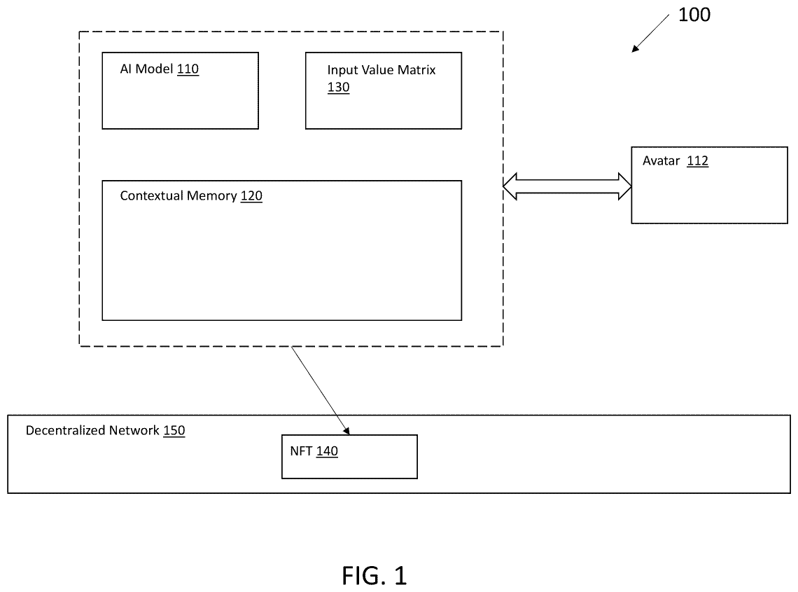

FIG. 1 illustrates a data structure of an agent in accordance with disclosed implementations. The data structure can be stored on non-transient computer readable media, such as a hard drive (spinning or solid state) optical media, or the like. Data structure 100 includes AI model 110, avatar 112, input value matrix 130, contextual memory 120 (storing the above-described cards), and Non-Fungible Token (NFT) 140. In this example, activity of avatar 112 within an execution environment (such as a metaverse game) is controlled by AI Model 110. However, the agent can relate to any entity and need not include an avatar. The elements need not be recorded on the same media. For example, they can be linked to one another through pointers, or by being stored in association with one another in a relational database. For example, in FIG. 1, NFT 140 is shown as being stored on a remote decentralized network (such as a blockchain) and associated with the other elements through a pointer. Each element of the data structure can be stored as a “module”, i.e., a set of data and/or instructions that, when processed in an execution environment, accomplishes the corresponding functions.

The cards stored in contextual memory 120 may be comprised of three distinct categories of data. The first level, referred to as intrinsic information, pertains to constant information inherent in the asset, such as a description of the object or general details transmitted to the AI agent. The intrinsic information can include detailed bio-tags that encapsulate the object's history, emotional significance, contextual importance, events and interactions over time.

The second level, known as dynamic information, refers to information that can be added or modified by the user or the asset's owner. The third level, known as event/interaction information, encompasses details about how the asset interacts with other assets and the outcomes transmitted to the player and AI during those interactions or events. For instance, consider a chest with a hidden treasure that requires a key for opening. The intrinsic information includes the chest's exterior details, while the event/interaction information reveals the hidden content when a specific interaction, such as a user using a virtual “key” to open the chest, occurs.

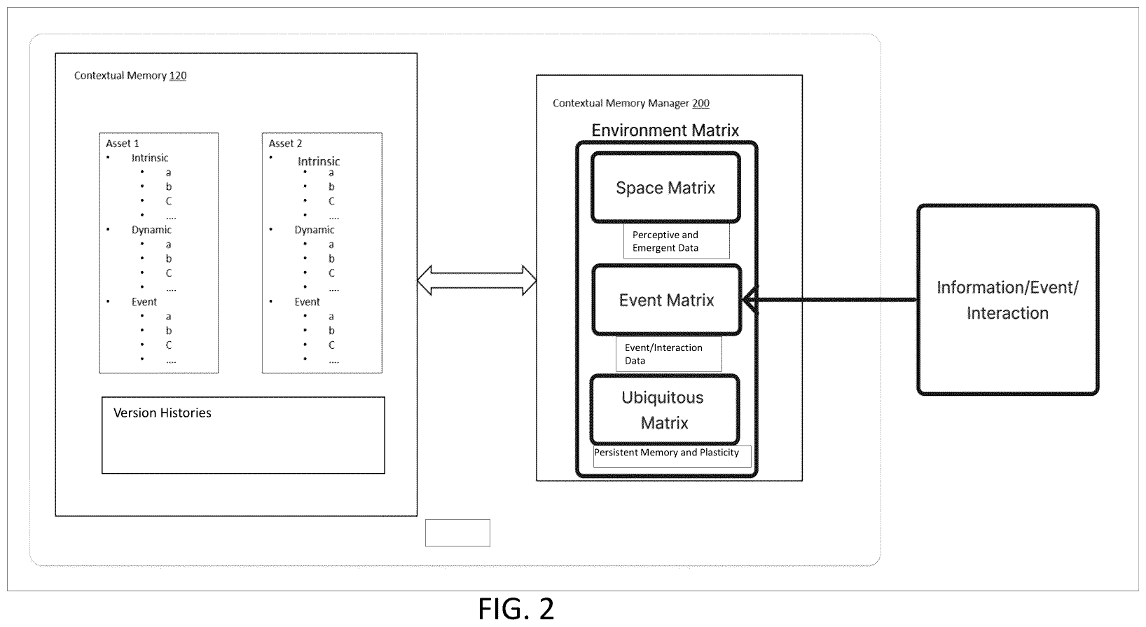

FIG. 2 schematically illustrates contextual memory 120, and the operation thereof, in more detail. Contextual memory 120 can be a database or other data structure. In the example of FIG. 2, contextual memory 120 stores contextual data in a predetermined ontology as the above-noted cards. Each card corresponds to an asset and thus includes data transmitted from and/or related to that asset. Only 2 cards are illustrated in FIG. 2 for simplicity. However, there can many cards depending on how many assets with which the AI model will potentially interact. Further, version histories of each card can be stored in contextual memory 120. In this simple example, the ontology is a tree-like structure and includes top level categories of Intrinsic, dynamic, and event. Intrinsic, Dynamic and Event data can be stored primarily in the card as a source of truth. All elements have the potential to be transferred to any agent interacting with a given card (or second/third hand from other agents possessing that information), depending on the depth of interaction and perception of those interactions.

Sub-categories are labeled as a, b, and c for simplicity in FIG. 2. Of course, there can be any number of subcategories of each category and any number of levels of categories and subcategories as need to express the context in any specific application. The specific design of the cards and contextual memory 120 for any specific application will be apparent to one of skill in the art based on the disclosure herein.

Contextual memory manager 200 can be an element of the execution environment, or can be provided as a service, and can apply rules and/or AI algorithms to select relevant contextual data to be stored in contextual memory 120 based on experiences of the agent. The experiences can include receipt of information, an event in the execution environment or an interaction of the corresponding agent within the execution environment. Contextual memory manager 200 can include an environment matrix capable of operating in 3 modes—a space matrix mode, an event matrix mode, and a ubiquitous matrix mode. These modes are described in more detail below.

For example, the contextual data can be used to simulate personal interpretation or perception of events as related to an Agents intrinsic characteristics and contextual history or recognize an emotional rating and importance factor for the information being perceived (such as, tone of voice, visual facial animation or expression, in addition to emotive language processing to interpret emotion) in addition to environmental context and spatial understanding to determine importance. This provides a threshold by which contextual memory manager 200 corresponding to a specific agent may choose to store or retrieve relevant memories and information, and to what extent that information might be recorded or retained as part of the contextual memory data. Further, memory manager 200 can provide plasticity and pruning or reinforcement of memories based on importance. As memories become less relevant or over time receive no trigger to be recalled or contextually considered, they may decay, or be pruned in accordance with one or more memory plasticity algorithms.

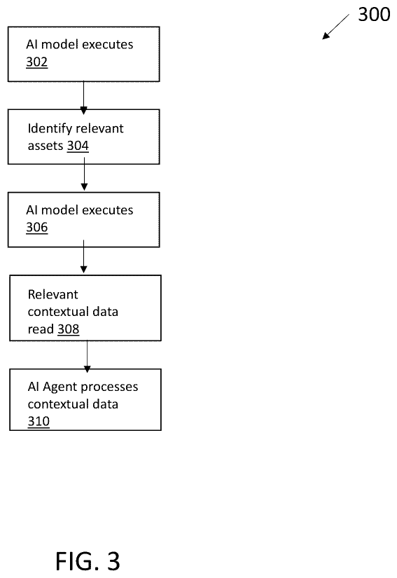

FIG. 3 illustrates a process of collecting and applying contextual data. Process 300 can begin with AI model 110 of the AI agent executing to cause avatar 112 to accomplish some sort of activity, such as enter a room, in step 302. At step 304 contextual memory manager 200 identifies relevant assets, such as other avatars in the room, and records contextual data associated with the assets into contextual memory 120 of AI agent 100. The data is stored in the contextual memory in accordance with the predefined ontology. At step 306, AI model 110 continues to execute. At step 308, relevant contextual data is mapped to inputs of the AI model to influence the behavior of avatar 112. The contextual data can be input into AI model 110 as training data and/or as independent input data in an inference operation.

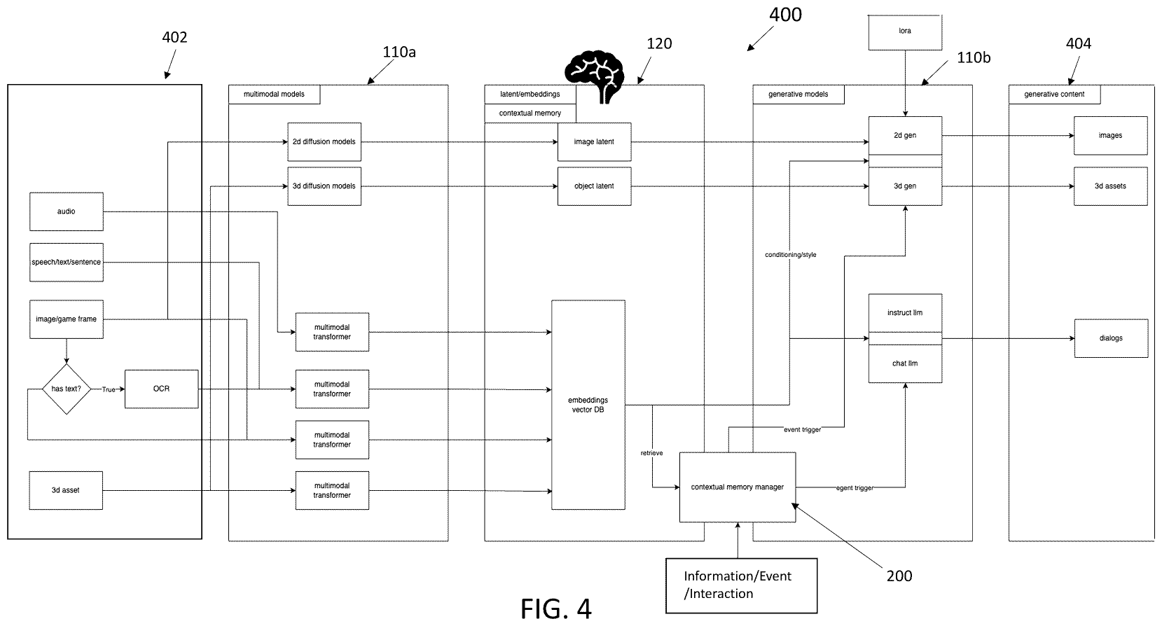

FIG. 4 illustrates system architecture 400 in accordance with disclosed implementations. Architecture 400 includes AI model 110, including multimodal models 110a and generative models 110b As illustrated, multimodal models 110a include diffusion models and transformers. Generative AI models 110b include 2d and 3d image generation models as well as chat an instruction models. Architecture 400 also include input module 402 and output module 404.

In operation, input module 402 receives inputs. Assuming the example of a character in a game or metaverse environment, the input can include audio input graphics/image input text input and/or 3d asset input. This input is received by a character during, for example, gameplay and can be processed for input into multimodal models 110a. For example, text input can be subject to Optical Character Recognition (OCR) prior to being input into a multimodal model.

Multimodal models 110a process the inputs, in a known manner. the diffusion models generate 2d images and/3d objects, and the transformers can generate various vector embeddings. These images, objects and embeddings are stored in contextual memory 120 in the manner described above. The images and objects can be selectively fed to generative models 110b, as inputs or training data, to generate 2d and 3d content as output at output module 404. The embeddings can be selectively passed to generative AI models 110b, as inputs or training data, based on control of contextual memory manager.

Because the contextual memory is persistently associated with the AI agent, the interactions and experiences, stored as contextual data, of the AI agent can be transferable with the AI agent across multiple execution environments. This means that the AI agent's learned behaviors, adaptations, and experiences can be preserved and carried over when the AI agent is transferred between different execution environments. This feature may enhance the continuity of experience for the AI agent, providing a more seamless and consistent user experience across different metaverse applications or platforms. As noted above, contextual memory manager 200 may operate in three distinct modes: 1) Space Matrix, 2) Event Matrix, and 3) Ubiquitous Matrix. These modes may be used to manage the interactions of the AI agent within the metaverse environment.

In the Space Matrix mode, information may be transmitted to the AI agent based on physical proximity in either a 2D or 3D space. For instance, in an open-world game, character movement may prompt information presentation based on their surroundings. This creates an immersive experience akin to “feeling a vibe” in the environment. Closer interactions evoke stronger sensations, influencing feelings of strength, agility, excitement, or even reflecting a brand's values. As one example, upon entering a dangerous area, the metadata exchange could cause the AI character/avatar to be apprehensive and more careful.

In the Event Matrix mode, information may be relayed to the AI agent upon an event trigger, such as a button click, user selection, or interaction with an object (e.g., being hit by a punch from another AI avatar, “exercising” in the metaverse environment, and the like). This mode allows for dynamic interactions within the metaverse environment, enhancing the user experience. As an example, an AI character could become temporarily disoriented upon being struck by a weapon or could become stronger after lifting heavy weights in a virtual gym.

In the Ubiquitous Matrix mode, information conveyed to the AI agent persists over time, representing the character's knowledge or memories. For example, in two different games or apps with distinct underlying Large Language Models (LLMs), if the avatar corresponding to an AI agent remains constant, each application comprehends the same history, backstory, and achievements associated with the agent. This mode can provide a sense of continuity and consistency across different metaverse applications, enhancing the user experience.

The contextual memory can store a variety of data types, including but not limited to, data representing the AI agent's actions, decisions, interactions with other AI agents or users, experiences within the execution environment, or other relevant contextual information. This data may be used to inform the AI agent's decision-making processes, influence its behaviors, and shape its interactions within the metaverse environment. The contextual memory may be configured to update dynamically based on the AI agent's ongoing interactions and experiences within the execution environment.

The contextual memory manager may be implemented in accordance with an “environment matrix”, a protocol that empowers the AI agents to comprehend 3D objects, avatars, and spaces. The environment matrix may facilitate the storage of events and interactions in 3D environments as long-term data, within contextual memories, that can propagate through contact, fostering shared consensus around knowledge and activities. The combination of the contextual memories and the environment matrix provides a comprehensive and dynamic system for managing AI agents in an execution environment. The environment matrix can operate in the modes discussed above (Space Matrix, Event Matrix, and Ubiquitous Matrix).

The AI agent's interactions with other elements in the execution environment are stored in the contextual memory through a dynamic process involving metadata exchange and object development. Every interaction—whether with Non-Player Characters (NPCs), other assets, or the environment itself—is processed through exchanges of metadata (referred to as “biotags”). These biotags are unique to each player and entity, evolving based on interactions. This allows for a detailed and personalized contextual memory for the AI agent, as every action and reaction contribute to the ongoing development of the object's metadata, influencing future interactions and behaviors.

By ensuring that metadata evolves according to personal engagements, the AI agent can deliver individualized experiences within each environment. This means the perception and responses of the AI agent are tailored to the unique history of interactions in each environment, allowing for a seamless transition of behaviors and narratives across different digital spaces, thereby enhancing the depth of engagement and experience.

The structure and content of the cards in the contextual memory are designed to encapsulate detailed metadata about each interaction, including the object's biotags, the nature of the interaction (e.g., dialogue, combat, transaction), and the emotional or contextual significance. These cards serve as dynamic memory units, continuously updated, and expanded with new interactions and experiences. They enable the AI agent to recall past interactions, predict future behaviors, and adjust its actions, accordingly, ensuring a rich, evolving narrative driven by player actions and interactions within the game world.

Contextual memory directly influences the emergent behaviors of the AI agent by serving as a foundation for learning and adaptation. As the AI processes and stores interactions within its contextual memory, it identifies patterns, preferences, and outcomes, leading to the development of new strategies, responses, and behaviors. This adaptive learning mechanism enables the AI agent to evolve, generating unpredictable and complex behaviors that contribute to a dynamic and immersive game world. The interplay between stored metadata and ongoing interactions fosters a cycle of continuous evolution and refinement of the AI agent's behavior, enhancing the game's depth and replay ability.

Consistent interpretation of the AI agent's attributes across multiple metaverse applications can be ensured through the integration of an open and p2p standardized metadata protocol. By storing key attributes and histories of interactions on this open data layer, data is immutable, secure, and universally accessible across different platforms. Users own the data related to their account and can permit applications to access that data. This uniform approach to data management allows for a seamless transition of AI agents and their attributes between different metaverse environments, ensuring that the core characteristics and learned behaviors remain intact and are interpreted consistently, regardless of the application or platform.

As described above, the AI agents' contextual memory stores contextual data relating to experiences of the agent, within the execution environments, enabling the transfer of these experiences across multiple execution environments. This data can be used to derive biotags, which are metadata that encapsulate the AI agents' experiences over time. The system can respond to the AI agents' activities within the execution environments by selecting one or more of these biotags and changing the attributes of the environments based on this subset. As a simple example, the user could be presented with a purchase interface for a product that corresponds to the selected biotag(s).

This dynamic adaptation of the execution environments allows, for example, the presentation of targeted content to the AI agents, changes in the behavior of assets within the environments, and the provision of interfaces, such as product purchase interfaces, to the AI agents. The system thus facilitates the integration of commercial opportunities within these digital environments, providing a platform for brands to engage with users in a more personalized and effective manner.

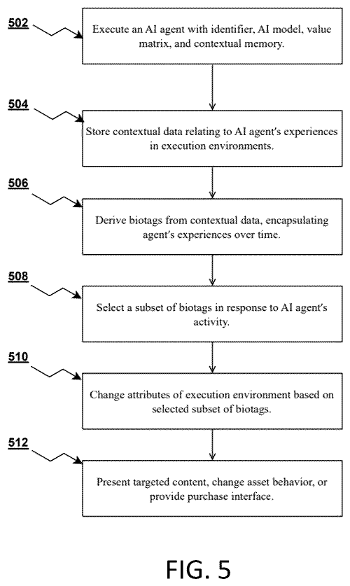

FIG. 5 illustrates a flowchart for a method of configuring parameters of an execution environment for an AI agent. The method begins with step 502, which involves executing an AI agent, the AI agent in this example including an identifier, AI model, value matrix, and contextual memory. At step 504 contextual data relating to the AI agent's experiences is stored. The process then moves to step 506, where biotags are derived from the contextual data. The biotags can encapsulate the agent's experiences over time. In step 508, a subset of biotags is selected in response to the AI agent's recent activity within the execution environment. Based on the selected subset of biotags, step 510 involves changing attributes of the execution environment. The final step in the flowchart, step 512, for example presents targeted content, changes asset behavior, or provides a purchase interface based on the attributes. Additional details of these steps are described below.

In some implementations, the contextual data may include data that relates to real-world experiences of a human associated with the AI agents, providing a bridge between physical and digital realities. Accordingly, the “experiences of the AI agent”, as used herein, can include experiences of the agent in the execution environment and experiences of a user associated with the AI agent outside of an execution environment, e.g., in the real world.

As noted above, biotags can be derived from contextual data. In the simplest example, one or more units of contextual data represent a biotag and thus the step of “deriving” a biotag can be merely selecting one or more units of contextual data. In more complex examples, deriving can include creating a separate data structure as the biotag that represents time-based experiences specified by multiple biotags. For example, if 4 units of contextual data indicate that the user ordered pizza on four different days, and 4 additional units of contextual data indicate the user watched a football game on those same days, a biotag can be derived from those 8 units of contextual data that specifies that the user is likely to buy a pizza on the day of a football game. This derivation can be accomplished in accordance with a preset rule or a learning model for example.

Further, the biotags may be associated with specific assets or elements within the execution environments. For instance, a biotag may be linked to a particular item in a virtual store, a specific character in an online game, or a certain scene in a streaming video. In such an example, the biotag may be derived by capturing the AI agent's interactions, as contextual data, with these assets or elements, such as the frequency of interaction, the duration of interaction, the type of interaction, and the AI agent's responses or reactions to the interaction.

The system and method for configuring attributes may be designed to operate within a broad spectrum of digital environments. These environments may include, but are not limited to, virtual reality (VR), augmented reality (AR), mixed reality (MR), online games, and streaming platforms. Each of these environments may offer unique opportunities for brand integration and user engagement, and the system may be configured to adapt to the specific characteristics and requirements of each environment.

For instance, in a VR environment, the system may create immersive brand experiences that fully engage the user's senses. This could involve the creation of virtual stores or showrooms where users can interact with products in a realistic manner. In an AR environment, the system may overlay digital brand content onto the user's physical surroundings, providing a seamless blend of real and virtual elements. In an MR environment, the system may integrate brand content into a hybrid reality that combines elements of both VR and AR.

In the context of online games, the system may integrate brand content into the game's narrative or gameplay mechanics. This could involve the creation of branded items or characters, or the incorporation of brand-related tasks or missions into the game. In streaming platforms, the system may present brand content in the form of interactive ads or sponsored content, which users can engage with while watching their favorite shows or streams.

In each of these environments, the system may leverage the capabilities of the AI agents and the dynamic metadata system to create personalized brand experiences. The AI agents may interact with the brand content in a manner that reflects the user's preferences and behaviors, while the dynamic metadata system may adapt the presentation of the brand content based on the user's interactions and activities within the environment.

The system may also integrate with other digital platforms or services to enhance the brand integration experience. For example, the system may link with social media platforms to share brand interactions, with eCommerce platforms to facilitate product purchases, or with data analytics platforms to gather insights on user engagement. This integration may be facilitated through APIs or SDKs, allowing for maximal interoperability and composability.

The biotags may be used to adapt the attributes of the execution environments in real-time. For example, the system may select a subset of the biotags in response to the AI agent's recent/current activity within the environments, and may change, for example, the presentation of content, the behavior of assets, or the availability of product purchase interfaces based on this subset. This dynamic adaptation of the environments may allow for a more personalized and relevant user experience, enhancing the effectiveness of brand integration.

The biotags may also be used to inform the AI model that determines the behavior of the AI agent. For instance, the AI model may be trained to recognize certain patterns or trends in the biotags, and may adjust the AI agent's behavior accordingly. This may allow the AI agent to learn from its experiences and adapt its behavior over time, further enhancing the personalization of user experiences.

The biotags may be stored and managed in a decentralized manner, such as on a blockchain. This may provide a secure and transparent record of the AI agent's experiences, enhancing the trustworthiness of the system. Further, the biotags may also be used as a fingerprint to verify the authenticity of the AI agent, further enhancing the security of the system.

The execution of the AI agent within the execution environments may involve the AI agent interacting with the various elements or assets within the environment. These interactions may involve various actions or behaviors, such as moving around the environment, interacting with objects or characters, performing tasks or missions, or responding to stimuli or events.

The system may employ real-time data analytics to curate user experiences within the execution environments. This may involve analyzing the AI agent's activities and interactions within the environments in real-time, and using this analysis to select a subset of the biotags. The selection of the biotags may be based on various factors, such as the frequency of the AI agent's interactions with certain elements or assets, the duration of these interactions, the type of these interactions, and the AI agent's responses or reactions to these interactions.

In some cases, the system may use advanced algorithms to analyze the contextual data stored in the AI agent's contextual memory and derive the biotags. These algorithms may be based on various data analysis techniques, such as data mining, pattern recognition, or machine learning, and may be designed to capture the nuances of the AI agent's experiences within the execution environments.

The system may alter the behavior of other assets within the execution environments based on the selected subset of biotags. These assets may include, but are not limited to, objects, characters, items, or elements within the environments. The behavior of these assets may be adjusted to reflect the AI agent's preferences and behaviors, as reflected in the biotags. This may involve changes in the assets' actions, reactions, movements, or interactions, enhancing the dynamism and immersion of the user experiences.

The use of NFTs, or other identifiers, may enable the creation of a digital provenance for the AI agent, providing a verifiable record of the AI agent's history and experiences. This digital provenance may be stored on the blockchain, providing a transparent and tamper-proof record that can be accessed and verified by all participants in the network.

As noted above, the contextual data stored in the AI agent's contextual memory may include data that relates to real-world experiences of a human associated with the AI agent. This integration of real-world experiences may provide a bridge between physical and digital realities, enhancing the relevance and personalization of the user experiences within the execution environments. For example, the system may gather data on the human's real-world activities, preferences, and behaviors, and incorporate this data into the AI agent's contextual memory. This data may be gathered through various means, such as through sensors, wearable devices, or user input, and may include a wide range of information, such as the human's physical activities, social interactions, consumption habits, or emotional states.

The system may use this real-world data to derive biotags that encapsulate the human's experiences over time. These biotags may serve as a form of dynamic metadata, providing a rich and detailed record of the human's activities and interactions in the real world. The system may then use these biotags to adapt the attributes of the execution environments in real-time, enhancing the personalization and relevance of the user experiences. For example, if the human frequently visits a certain type of restaurant in the real world, the system may derive a biotag that encapsulates this preference. The system may then use this biotag to present targeted content to the AI agent within the execution environments, such as advertisements for similar types of restaurants, or virtual experiences that replicate the ambiance of these restaurants.

The integration of real-world experiences may also enhance the AI agent's ability to mimic the human's behaviors and preferences within the execution environments. For instance, the AI model associated with the AI agent may be trained to recognize certain patterns or trends in the real-world data, and may adjust the AI agent's behavior accordingly. This may allow the AI agent to act as a more accurate and personalized representation of the human within the digital realms, further enhancing the effectiveness of brand integration. The real-world data can also be used to inform the value matrix associated with the AI agent, allowing the AI agent to evolve and adapt over time in a manner that reflects the human's real-world experiences.

The system may also facilitate limited-time or event-specific brand partnerships within the virtual environments. For instance, a brand may partner with the system to create a unique virtual experience for a specific event, such as a concert, a sports game, or a product launch. During this event, the system may present targeted content to the AI agent based on the selected subset of biotags, enhancing the relevance and effectiveness of the brand integration. This may involve the presentation of exclusive promotions or discounts, the creation of branded items or characters, or the incorporation of brand-related tasks or missions into the virtual experience.

An auction mechanism can be implemented to allow brands to bid for premium spots within the execution environments. This auction mechanism may be designed to maximize the visibility and impact of brand content, while also generating revenue for the platform participants. The auction mechanism may operate in real-time, with brands bidding against each other for the opportunity to present their content in the most prominent or desirable locations within the environments. The auction mechanism may be based on various auction models, such as first-price auctions, second-price auctions, or sealed-bid auctions, and may be designed to ensure a fair and transparent bidding process.

The environment matrix, the value matrix, and the contextual memory may work together to manage the AI agent's interactions within the metaverse environment. As noted above, the value matrix may define the attributes of the AI agent, while the contextual memory may store data associated with the AI agent based on interactions within the environment based on the environment matrix protocol. This combination provides a comprehensive and dynamic system for managing AI agents in a metaverse environment.

The various AI models can be of known construction. the diffusion models of disclosed implementations can be, known diffusion models that start with existing data (e.g., an image) and progressively add random noise to it. This noisy data is then transformed into a structured output. Diffusion models are trained to undo the noise addition step by step, gradually revealing the original content. This enables diffusion models to generate accurate and detailed content as outputs. For example, they can generate lifelike images or produce coherent text sequences.

The multimodal transformers of disclosed implementations can be conventional transformer in which a neural network architecture is designed to handle data from multiple modalities (such as text, images, and audio) simultaneously. Transformers use self-attention mechanisms to process sequences of tokens. One example is a Vision Transformer (ViT) which adapts transformers for image data by dividing an image into fixed-size patches and treating them as tokens. These transformers merge information from different modalities. For example, they can process both image patches and text tokens together. Techniques that can be used by the multimodal transformers include cross-modal attention and fusion processes.

A number of implementations have been described. Nevertheless, it will be understood that various modifications may be made without departing from the spirit and scope of the disclosure. Accordingly, other implementations are within the scope of the following claims.

What is claimed:

1. A computer-implemented method for configuring attributes of at least one execution environment for and artificial intelligence (AI) agent, the method comprising:
executing an AI agent, the AI agent including an identifier, an AI model that determines behavior of the AI agent, a value matrix that defines attributes of the AI agent, and a contextual memory associated with the AI agent, wherein the contextual memory is configured to store contextual data relating to experiences of the AI agent in the at least one
execution environment, whereby the experiences are transferable with the AI agent across multiple execution environments;
deriving at least one biotag from the contextual data, wherein the at least one biotag encapsulates experiences of the agent over time;
in response to activity of the AI agent within the at least one execution environment, selecting a subset of the at least one biotags; and
changing attributes of the at least one execution environment based on the subset of the at least one biotag.

2. The method of claim 1, wherein the identifier is recorded on a decentralized ledger.

3. The method of claim 2, wherein the identifier is a non-fungible token (NFT).

4. The method of claim 1, wherein changing attributes of the at least one execution environment includes at least one of, presenting targeted content to the AI agent in the at least one execution environment, changing behavior of assets in the at least one execution environment, and/or providing a product purchase interface to the AI agent in the at least one execution environment.

5. The method of claim 1, wherein the contextual memory comprises a plurality of cards, each card containing data representing an interaction or attribute of a specific asset within at least one of the at least one execution environment.

6. The method of claim 5, wherein the data on the cards includes at least one of intrinsic information, dynamic information, and event information related to the specific asset.

7. The method of claim 3, wherein the non-fungible token (NFT) is used to verify at least one of the authenticity and/or ownership of the AI agent.

8. The method of claim 1, wherein the value matrix includes attributes selected from the group consisting of: skills, appearance, knowledge, performance metrics, and user-defined characteristics.

9. The method of claim 1, wherein the contextual memory is dynamically updated based on the interactions and activities of the AI Agent within the at least one execution environment.

10. The method of claim 1, wherein the at least one execution environment includes at least one of virtual reality, augmented reality, and gaming platforms.

11. The method of claim 1, wherein the contextual data includes data that relates to real-world experiences of a human associated with the AI agent.

12. A computer system for configuring attributes of at least one execution environment for and artificial intelligence (AI) agent, the system comprising:
at least one computing processor;
at least one memory operatively coupled to the at least on computing processor and storing computer-readable instructions which, when executed by the at least one computing processor, cause the at least one computing processor to carry out a method of:
executing an AI agent, the AI agent including an identifier, an AI model that determines behavior of the AI agent, a value matrix that defines attributes of the AI agent, and a contextual memory associated with the AI agent, wherein the contextual memory is configured to store contextual data relating to experiences of the AI agent in the at least one execution environment, whereby the experiences are transferable with the AI agent across multiple execution environments;
deriving at least one biotag from the contextual data, wherein the at least one biotag encapsulates experiences of the agent over time;
in response to activity of the AI agent within the at least one execution environment, selecting a subset of the at least one biotags; and
changing attributes of the at least one execution environment based on the subset of the at least one biotag.

13. The system of claim 12, wherein the identifier is recorded on a decentralized ledger.

14. The system of claim 13, wherein the identifier is a non-fungible token (NFT).

15. The system of claim 12, wherein changing attributes of the at least one execution environment includes at least one of, presenting targeted content to the AI agent in the at least one execution environment, changing behavior of assets in the at least one execution environment, and/or providing a product purchase interface to the AI agent in the at least one execution environment.

16. The system of claim 12, wherein the contextual memory comprises a plurality of cards, each card containing data representing an interaction or attribute of a specific asset within at least one of the at least one execution environment.

17. The system of claim 16, wherein the data on the cards includes at least one of intrinsic information, dynamic information, and event information related to the specific asset.

18. The system of claim 14, wherein the non-fungible token (NFT) is used to verify at least one of the authenticity and/or ownership of the AI agent.

19. The system of claim 12 wherein the value matrix includes attributes selected from the group consisting of: skills, appearance, knowledge, performance metrics, and user-defined characteristics.

20. The system of claim 12, wherein the contextual memory is dynamically updated based on the interactions and activities of the AI Agent within the at least one execution environment.

21. The system of claim 12, wherein the at least one execution environment includes at least one of virtual reality, augmented reality, and gaming platforms.

22. The system of claim 12, wherein the contextual data includes data that relates to real-world experiences of a human associated with the AI agent.
